(19) United States
(12) Patent Application Publication
(10) Pub. No.: US 2026/0175296 A1
(43) Pub. Date: Jun. 25, 2026

(54) CERAMIC MATERIAL AND PREPARATION METHOD AND USE THEREOF

(71) Applicant: North University of China, Taiyuan (CN)

(72) Inventors: Bin LIU, Taiyuan (CN); Chenglong BI, Taiyuan (CN); Yu WANG, Taiyuan (CN); Shenghua ZHANG, Taiyuan (CN); Zhonghua LI, Taiyuan (CN); Shengtong HE, Taiyuan (CN)

(73) Assignee: North University of China, Taiyuan (CN)

(21) Appl. No.: 19/084,834

(22) Filed: Mar. 20, 2025

(30) Foreign Application Priority Data
Dec. 24, 2024 (CN) 202411919563.0

(51) Int. Cl. B22F 10/60; B33Y 40/20; B33Y 80/00

(52) U.S. Cl. CPC B22F 10/60; B33Y 40/20; B33Y 80/00; B22F 2301/205

(57) ABSTRACT

Disclosed are a ceramic material and a preparation method and use thereof, belonging to the technical field of ceramic materials. The ceramic material includes a titanium alloy with a porous lattice structure, a ceramic, and an aluminum alloy; where the porous lattice structure is provided with voids; the ceramic is embedded in the voids; and the aluminum alloy fills in the porous lattice structure.

### CROSS REFERENCE TO THE RELATED APPLICATIONS

This application is based upon and claims priority to Chinese Patent Application No. 202411919563.0, filed on Dec. 24, 2024, the entire contents of which are incorporated herein by reference.

### TECHNICAL FIELD

The present disclosure relates to the technical field of ceramic materials, and in particular to a ceramic material, and a preparation method and use thereof.

### BACKGROUND

With the continuous progress and development of defense technology, higher requirement is imposed on the performance of protective armor materials. Due to their high hardness, high melting point, light weight and excellent energy-absorbing property during breaking, ceramic materials are becoming increasingly important in applications requiring both a light weight and the maintenance of a high protecting capability. However, with a high brittleness, the ceramic easily cracks when exposed to a larger impact force, which may lead to the loss of protecting effect of the armor after a great impact. In addition, the area of the ceramic capable of providing effective protection is typically only about 50% of that of surface, and peripheral ceramic do not have the capability of providing effective protection.

To overcome these limitations, ceramic armor plates are often combined with other materials such as metals or polymers to form a composite armor, which combines the advantages of various materials to minimize brittleness defects of ceramics, thereby enhancing the protecting effect and durability of the whole structure. Further studies show that when ceramic is closely coated with other materials, the area capable of providing effective protection increases significantly, and thereby ceramic protection plates have an improved impact resistance and a prolonged service life. How to achieve the encapsulation of ceramic has become a technical problem to be solved in the field.

### SUMMARY

An object of the present disclosure is to provide a ceramic material and a preparation method and use thereof. The ceramic material provided by the disclosure could encapsulate a ceramic, and the whole material is dense, without obvious defects.

In order to achieve the aforementioned object, the disclosure provides the following technical solutions:

The disclosure provides a ceramic material, including a titanium alloy with a porous lattice structure, a ceramic, and an aluminum alloy; where
the porous lattice structure is provided with voids;
the ceramic is embedded in the voids; and
the aluminum alloy fills in the porous lattice structure.

In some embodiments, the voids each are in a cylindrical shape.

In some embodiments, the voids each have a diameter of 17-19 mm and a height of 10-35 mm.

In some embodiments, a structural unit in the porous lattice structure has a dimension selected from the group consisting of 9×9×9 mm, 12×12×12 mm and 15×15×15 mm.

In some embodiments, a volume fraction of the structural unit is in a range of 10-30%.

The disclosure also provides a method for preparing the ceramic material described in the aforementioned technical solutions, including steps of:
(1) preparing the titanium alloy using an additive manufacturing process;
(2) embedding the ceramic in the voids of the titanium alloy obtained in step (1) to obtain an intermediate; and
(3) casting by pouring an aluminum alloy molten liquid into the intermediate obtained in step (2), to obtain the ceramic material.

In some embodiments, a laser used in the additive manufacturing process in step (1) has a scan speed of 700-1,300 mm/s, a power of 180-270 W, a scan spacing of 0.07-0.09 mm, and a scan delay time of 10-15 μs.

In some embodiments, the aluminum alloy molten liquid in step (3) has a temperature of 680-720° C.

In some embodiments, the casting in step (3) is performed in a low-pressure casting machine.

The disclosure also provides use of the ceramic material described in the aforementioned technical solutions or the ceramic material prepared by the method described in the aforementioned technical solutions in protective armor plates.

The disclosure provides a ceramic material, including a titanium alloy with a porous lattice structure, a ceramic, and an aluminum alloy; where the porous lattice structure is provided with voids; the ceramic is embedded in the voids; and the aluminum alloy fills in the porous lattice structure. In the disclosure, the embedment of a ceramic in the voids of titanium alloy and the filling of an aluminum alloy in a porous lattice structure of the titanium alloy enable the aluminum alloy and the titanium alloy to encapsulate the ceramic, and an interpenetrating structure of the aluminum alloy and the titanium alloy is used to realize an interpenetrating arrangement of a hard material and a soft material, thus improving the encapsulating effect on the ceramic. Experimental results show that ceramic is tightly confined in the ceramic material, and the whole material is dense and defect-free.

### BRIEF DESCRIPTION OF THE DRAWINGS

FIG. 1A is a curve showing the relationship between constant C and the volume fraction of a structural unit; FIG. 1B shows a schematic diagram of a structural unit.

FIG. 2 shows a structural schematic diagram of the structural unit with a volume fraction of 10% in the titanium alloy in Example 1;

FIG. 3 shows a structural schematic diagram of a top view of the titanium alloy in Example 1;

FIG. 4 shows a structural schematic diagram of the titanium alloy in Example 1;

FIG. 5 shows a structural schematic diagram of the titanium alloy in Example 1;

FIG. 6 shows a structural schematic diagram of a top view of the intermediate in Example 1;

FIG. 7 shows a structural schematic diagram of the intermediate in Example 1;

FIG. 8 shows a structural schematic diagram of the intermediate in Example 1;

FIG. 9 shows a structural schematic diagram of the structural unit with a volume fraction of 20% in the titanium alloy in Example 2;

FIG. 10 shows a structural schematic diagram of the low-pressure casting machine used in Example 1;

FIG. 11 shows an industrial CT diagram of the ceramic material prepared in Example 1; and

FIG. 12 shows an industrial CT diagram of the ceramic material prepared in Example 2.

### DETAILED DESCRIPTION OF THE EMBODIMENTS

The disclosure provides a ceramic material, including a titanium alloy with a porous lattice structure, a ceramic, and an aluminum alloy; where
the porous lattice structure is provided with voids;
the ceramic is embedded in the voids; and
the aluminum alloy fills in the porous lattice structure.

In the disclosure, the ceramic material includes a titanium alloy with a porous lattice structure; and the porous lattice structure is provided with voids. In the disclosure, the voids are configured to be filled with ceramic, and pores of the titanium alloy remained after filling ceramic, namely, the porous lattice structure is configured to be filled with an aluminum alloy, so that the aluminum alloy and the titanium alloy encapsulate the ceramic.

In some embodiments of the disclosure, the voids each are in a cylindrical shape; in some embodiments, the voids each have a diameter of 17-19 mm, preferably 18 mm; in some embodiments, the voids each have a height of 10-35 mm. As an embodiment, the voids each have a height of 20 mm or 30 mm.

In the disclosure, there are no particular limitations on the height of the titanium alloy, so long as it is not more than the height of voids.

In some embodiments of the disclosure, the titanium alloy includes a plurality of voids; in some embodiments, the plurality of voids are arranged in parallel rows and columns in a horizontal direction; and in some embodiments, the distance between circle centers of two adjacent voids is in a range of 19-21 mm, preferably 20 mm.

In some embodiments of the disclosure, the structural unit in the porous lattice structure has a dimension selected from the group consisting of 9×9×9 mm, 12×12×12 mm and 15×15×15 mm; and in some embodiments, the volume fraction of the structural unit is in a range of 10-30%. In the disclosure, the porosity of the porous lattice structure could be regulated by limiting the dimension of a structural unit within the aforementioned range.

As an embodiment, the volume fraction of the structural unit may be 10%, 20% or 30%.

In the disclosure, the mathematical formula of the structural unit is as shown in Equation I.

$$∅ ( r ) = cos ( 2 π x ) + cos ( 2 π y ) + cos ( 2 π z ) = C ; \qquad Equation I$$

In Equation I, x, y and z each represent spatial coordinates of curved face points, and C is a constant. In the disclosure, a porous lattice structure could be obtained according to Equation I.

In the disclosure, C is used to adjust the volume fraction of the structural unit. In the disclosure, there are no particular limitations on how to use C to adjust the volume fraction of the structural unit, and the operation may be conducted in accordance with common knowledge.

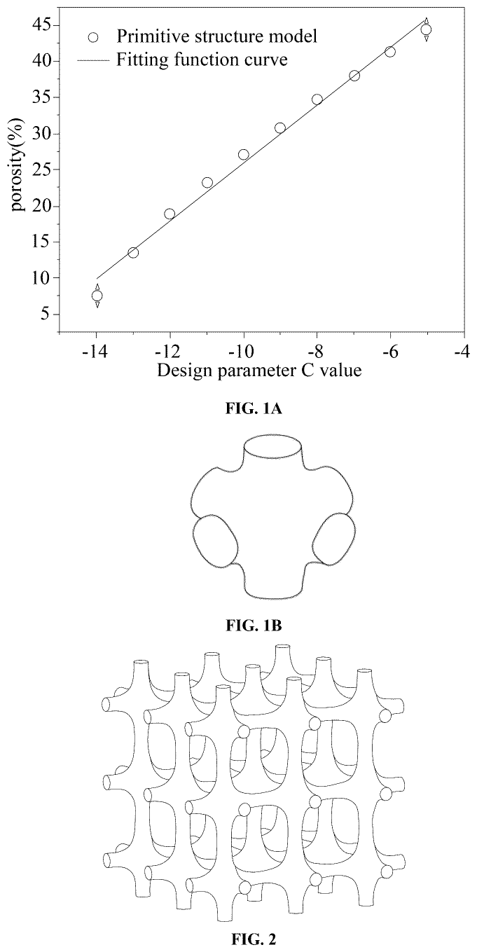

As an embodiment, the relationship between C and the volume fraction of a structural unit is as shown in FIG. 1A.

The correspondence relationship between constant C and the volume fraction of structural unit can be seen from FIG. 1A.

In some embodiments of the disclosure, the titanium alloy is TC4, Ti-6Al-4V or Ti-6Al-7Nb.

In the disclosure, the ceramic material further includes a ceramic; and the ceramic is embedded in the voids. In the disclosure, the ceramic is a hard material for improving the strength of the ceramic material.

In some embodiments of the disclosure, the ceramic is in a cylindrical shape. In the disclosure, there are no particular limitations on the dimension of the cylinder, so long as the voids of the titanium alloy are completely filled up.

In some embodiments of the disclosure, the ceramic is made of SiC.

In the disclosure, the ceramic material further includes an aluminum alloy; and the aluminum alloy fills in the porous lattice structure. In the disclosure, the aluminum alloy is a soft material for improving the toughness of the ceramic material.

In the disclosure, there are no particular limitations on the shape of the aluminum alloy, so long as the voids of the ceramic material is completely filled.

In some embodiments of the disclosure, the aluminum alloy includes the following chemical components: in mass percentages, 6.0-8.0% of Si, 1.3-2.0% of Cu, 0.2-0.4% of Mg, 0.15-0.25% of Mn, 0.05-0.15% of Ti, 0.02-0.05% of B, 0.05-0.1% of Cr and the balance of Al.

As an embodiment, a designation of the aluminum alloy is A356.

In the disclosure, the embedment of ceramic in the voids of titanium alloy and the filling of an aluminum alloy in the porous lattice structure of the titanium alloy enable the aluminum alloy and the titanium alloy to encapsulate the ceramic, and an interpenetrating structure of the aluminum alloy and the titanium alloy is used to realize an interpenetrating arrangement of a hard material and a soft material, thus improving the encapsulating effect on the ceramic.

The disclosure also provides a method for preparing the ceramic material described in the aforementioned technical solutions, including steps of:
(1) preparing the titanium alloy using an additive manufacturing process;
(2) embedding the ceramic in voids of the titanium alloy obtained in step (1) to obtain an intermediate; and
(3) casting by pouring an aluminum alloy molten liquid into the intermediate obtained in step (2), to obtain the ceramic material.

In the disclosure, there are no particular limitations on the source of ingredients, and commercially-available products well known to those skilled in the art may be used.

In the disclosure, the titanium alloy is prepared by an additive manufacturing process.

In some embodiments of the disclosure, the additive manufacturing process includes steps of:
1) constructing a three-dimensional model of the titanium alloy using a computer software, to obtain dimensional data of the titanium alloy; and
2) performing additive manufacturing according to the dimensional data of the titanium alloy obtained in step 1) to obtain the titanium alloy.

In some embodiments of the disclosure, a computer software is used to construct a three-dimensional model of the titanium alloy and obtain the dimensional data of the titanium alloy.

In the disclosure, there are no particular limitations on how to use the computer software to construct the three-dimensional model of the titanium alloy and obtain the dimensional data of titanium alloy, and the operation well known to those skilled in the art may be adopted.

In some embodiments of the disclosure, after the dimensional data of the titanium alloy are obtained, an additive manufacturing is conducted according to the dimensional data of the titanium alloy so as to obtain the titanium alloy.

In some embodiments of the disclosure, the additive manufacturing is performed in a selective laser melting (SLM) device. In the disclosure, there are no particular limitations on the type of the selective laser melting device, and a device well known to those skilled in the art may be used.

In some embodiments of the disclosure, a substrate is mounted in a molding chamber of the selective laser melting device prior to the additive manufacturing. In the disclosure, there are no particular limitations on how to mount the substrate in the molding chamber of the selective laser melting device, and operations well known to those skilled in the art may be adopted. In the disclosure, the stability of the additive manufacturing process could be ensured by mounting the substrate in the molding chamber of the selective laser melting device.

In some embodiments of the disclosure, process parameters of the selective laser melting device include: a substrate temperature of 110-130° C., a feed base of 1.0-1.3, a feed multiple of 1.1-1.4, an air flow rate of fan being 3.0-4.0 m/s, an oxygen content being not more than 0.1 wt %, and a pressure of chamber and a differential pressure of filtering screen each independently being 40-50 mbar.

As an embodiment, the process parameters of the selective laser melting device may be as follows: a substrate temperature of 115-125° C., a feed base of 1.1-1.2, a feed multiple of 1.2-1.3, an air flow rate of fan being 3.2-3.6 m/s, an oxygen content being not more than 0.1 wt %, and a pressure of chamber and a differential pressure of filtering screen each independently being 42-46 mbar.

In some embodiments of the disclosure, during the additive manufacturing, the scan speed of a laser is in a range of 700-1,300 mm/s; in some embodiments, the power of the laser is in a range of 180-270 W; in some embodiments, the scan spacing of the laser is in a range of 0.07-0.09 mm; and in some embodiments, the scan delay time of the laser is in a range of 10-15 μs. In the disclosure, melting process and structural precision could be ensured by limiting the process parameters of additive manufacturing within the aforementioned range.

As an embodiment, during the additive manufacturing, the scan speed of a laser is in a range of 800-1,200 mm/s, and may also be 900-1,000 mm/s; the power of the laser may be 190-250 W, and may also be 230-240 W; the scan spacing of the laser may be 0.075-0.08 mm; and the scan delay time of the laser may be 13-14 μs.

In some embodiments of the disclosure, the additive manufacturing is performed in a protective atmosphere; and in some embodiments, the protective atmosphere is argon. In the disclosure, the oxidation could be prevented by performing the additive manufacturing in a protective atmosphere.

In some embodiments of the disclosure, after the completion of additive manufacturing, the product obtained by additive manufacturing is subjected to a post-treatment, so as to obtain a titanium alloy.

In some embodiments of the disclosure, the post-treatment is performed by an alkali washing, an acid washing, an alcohol washing, plating and drying performed in sequence.

In some embodiments of the disclosure, a detergent used for the alkali washing is a NaOH solution; in some embodiments, the NaOH solution has a mass concentration of 5-10%; and in some embodiments, the alkali washing is conducted for 10-20 min. In the disclosure, the grease contamination on titanium alloy surface could be removed by limiting the process parameters of alkali washing within the aforementioned range.

As an embodiment, the NaOH solution has a mass concentration of 6-10%; and in some embodiments, the alkali washing is conducted for 12-15 min.

In some embodiments of the disclosure, a detergent used for the acid washing is hydrochloric acid; in some embodiments, a mass concentration of the hydrochloric acid is in a range of 5-10%; and in some embodiments, the acid washing is conducted for 10-20 min. In the disclosure, the oxide layer on titanium alloy surface could be removed by limiting the process parameters of acid washing within the aforementioned range.

As an embodiment, the mass concentration of the hydrochloric acid is in a range of 6-10%; and the acid washing is conducted for 12-15 min.

In the disclosure, there are no particular limitations on how to perform the alcohol washing, and operations well known to those skilled in the art may be adopted, as long as cleanness is achieved. In the disclosure, through alcohol washing, it can be ensured that the titanium alloy meets the cleanliness standard required for low-pressure casting.

In some embodiments of the disclosure, a plating solution used for the plating is a mixed solution of K₂ZrF₆ and NaF; in some embodiments, the mass concentration of K₂ZrF₆ in the mixed solution is 8.3%; in some embodiments, the mass concentration of NaF in the mixed solution is 0.08%; in some embodiments, the plating is conducted for 10-30 min; and in some embodiments, the plating is conducted at a temperature of 60-90° C. In the disclosure, the oxidation of titanium alloy could be prevented through plating.

As an embodiment, the plating is conducted for 15-25 min; and the plating is conducted at a temperature of 70-90° C.

In some embodiments of the disclosure, the drying is conducted at a temperature of 150-250° C.; and in some embodiments, the drying is conducted for 10-15 min. In the disclosure, a more uniform plating could be ensured through drying.

In the disclosure, after the titanium alloy is obtained, ceramic is embedded in the voids of the titanium alloy to obtain an intermediate.

In some embodiments of the disclosure, the ceramic is subjected to surface treatment prior to use. In the disclosure, the bonding effect of ceramic and metal could be improved by performing surface treatment on ceramic.

In some embodiments of the disclosure, the surface treatment includes sanding, etching, modification and drying performed in sequence.

In the disclosure, there are no particular limitations on how to perform sanding, and operations well known to those skilled in the art may be adopted. In the disclosure, the contaminants on the surface could be removed by sanding ceramic surface.

In some embodiments of the disclosure, the etching is performed in a hydrofluoric acid solution; in some embodiments, the hydrofluoric acid solution has a mass concentration of 5-10%; and in some embodiments, the etching is conducted for 5-20 min. In the disclosure, there are no particular limitations on the temperature for the etching, and it may be performed at room temperature. In the disclosure, through etching, the natural oxide layer and other impurities on the ceramic surface could be removed, so that the fresh surface is exposed, and its chemical bonding to metal is enhanced.

As an embodiment, the hydrofluoric acid solution has a mass concentration of 6-8%; and the etching is conducted for 10-15 min.

In some embodiments of the disclosure, the modification is performed in a silane coupling agent solution; in some embodiments, the silane coupling agent solution has a mass concentration of 0.5-2%; in some embodiments, the silane coupling agent is (3-aminopropyl)triethoxysilane; and in some embodiments, the modification is conducted for 5-30 min. In the disclosure, there are no particular limitations on the temperature for the modification, and it may be performed at room temperature. In the disclosure, the bonding strength of ceramic and metal could be improved through modification.

As an embodiment, the silane coupling agent solution has a mass concentration of 1.0-1.5%; and the modification is conducted for 8-25 min, and maybe also for 15-20 min.

In some embodiments of the disclosure, the drying is conducted at 200° C.; and in some embodiments, drying is conducted for 10-15 min. In the disclosure, during drying, silane molecules self-assemble to form a monomolecular layer, which not only promotes the chemical bonding to metal molten liquid, but also serves as a stress buffer layer to reduce the internal stress caused by the difference between thermal expansion coefficients.

In the disclosure, there are no particular limitations on how to embed the ceramic in the voids of the titanium alloy, and the operation may be conducted in accordance with common knowledge.

In the disclosure, after an intermediate is obtained, an aluminum alloy is poured into the intermediate for casting, to obtain the ceramic material.

In some embodiments of the disclosure, the casting is performed in a low-pressure casting machine. In the disclosure, there are no particular limitations on the type of the low-pressure casting machine, and a device well known to those skilled in the art may be used.

In some embodiments of the disclosure, the upper chamber of the low-pressure casting machine is preheated prior to the casting; in some embodiments, the preheating is conducted at a temperature of 250-400° C.; and in some embodiments, the preheating is conducted for not less than 15 min. In the disclosure, by preheating the upper chamber of the low-pressure casting machine, a uniform temperature distribution in the upper chamber could be ensured, and any potential temperature difference is eliminated, which do full preparation for the casting procedure.

In some embodiments of the disclosure, the aluminum alloy molten liquid has a temperature of 680-720° C. As an embodiment, the aluminum alloy molten liquid has a temperature of 690-700° C.

In some embodiments of the disclosure, the aluminum alloy molten liquid is smelted in a lower chamber of a low-pressure casting machine; and in some embodiments, the process parameters of the smelting include: the smelting temperature being 680-720° C., the current across electrode of electromagnetic pump being 1,000-1,500 A, the current in electromagnetic coil being 40-60 A, and the smelting time being not less than 1 h. In the disclosure, by limiting the process parameters of smelting within the aforementioned range, the full melting of aluminum alloy could be ensured, which does good preparation for the subsequent casting procedure.

In some embodiments of the disclosure, the vacuum degree of the upper chamber during smelting is 2×10⁻¹ Pa. In the disclosure, the vacuum degree of the upper chamber is controlled to form an environment with a high vacuum degree of 2×10⁻¹ Pa, so that the aluminum alloy could fill the pores of titanium alloy more effectively, and the omissions in casting are greatly reduced; and additionally, the high vacuum of upper chamber also helps to form a pressure difference between upper and lower chambers, so that the aluminum alloy molten liquid in the lower chamber smoothly rises to the mold of upper chamber, which not only optimizes the filling effect of the aluminum alloy molten liquid, but also reduces the pressurization required for lower chamber, resulting in a reduced energy consumption.

In some embodiments of the disclosure, the pressure of the lower chamber during casting is in a range of 0.3-0.6 MPa. In the disclosure, by limiting the pressure of lower chamber within the aforementioned range, a significant pressure difference between upper and lower chambers could be generated, so that the aluminum alloy molten liquid in the lower chamber is pressed into the mold of upper chamber to undergo a solid-liquid compounding with the intermediate.

As an embodiment, the pressure of lower chamber during casting may be in a range of 0.4-0.5 MPa.

In some embodiments of the disclosure, the pressure of lower chamber is maintained for 10-25 min. In the disclosure, the time for which the pressure of lower chamber is maintained is limited within the aforementioned range, and thereby it can be ensured that the aluminum alloy molten liquid uniformly fill up the mold to form a uniform and stable interpenetrating structure with the composite material.

In some embodiments of the disclosure, after the completion of casting, the product obtained through the casting is sanded and then cut, so as to obtain the ceramic material.

In the disclosure, there are no particular limitations on how to perform the sanding, so long as the burrs and rough portions on the surface of the product obtained through casting could be removed.

In the disclosure, there are no particular limitations on how to perform the cutting, and cutting well known to those skilled in the art may be adopted as long as the desired target dimension is achieved.

In the disclosure, an additive manufacturing technology is adopted first to prepare a titanium alloy scaffold that has a porous lattice structure and that is pre-embedded with the ceramic; Next, titanium alloy and ceramic are subjected to surface treatment, and the treated ceramic and the scaffold are assembled, and then mounted in a low-pressure casting mold; Finally, by adjusting the preheating of a low-pressure casting machine, smelting, vacuumizing upper chamber, pressurizing lower chamber and other steps, the pressure difference between the pressurized lower chamber and the vacuumized upper chamber is achieved, so that the aluminum alloy molten liquid fully fills the mold from bottom to top, so as to prepare a ceramic material with an interpenetrating structure. In the disclosure, the high hardness, high melting point and excellent energy-absorbing property of the ceramic are fully utilized to provide protection against impact. Additionally, the combination with a light-weight titanium-aluminum material having an interpenetrating structure offers a synergistic toughening effect to mitigate the fragility of the ceramic, and the shrinkage stress resulting from the solidification during casting is utilized to seal and coat the ceramic, which significantly increases the area of ceramic material capable of providing effective protection.

In the disclosure, an additive manufacturing technology is used to prepare a scaffold with a porous lattice structure, so that ceramic could be precisely placed in a predetermined position. Additionally, in the disclosure, it is ensured that the aluminum alloy molten liquid during low-pressure casting could effectively fill and coat a protective ceramic material to realize the interpenetrating arrangement of hard and soft materials as well as the combination of metallurgy and machinery, thereby improving the strength and overall toughness of composite armor plate, and mitigating the brittleness of the ceramic. By this method, a protective encapsulated ceramic plate material with an interpenetrating structure could be prepared in one step.

The coating material used in the disclosure is light-weight titanium alloy and aluminum alloy differing significantly from each other in physical and chemical properties, so that a tough bioinspired interpenetrating structure could be formed to improve the mechanical performance of the whole protection plate; Compared with a conventional top-down casting method, the disclosure employs a low-pressure casting technology in which a metal molten liquid is controlled to fill a mold from bottom to top under the action of a pressure difference. By the method, the flowing of liquid is smoother, and turbulence decreases, which reduces the generation of pores and inclusions. Additionally, the uniform cooling of a casting helps to reduce hot tearing and stress concentration. Furthermore, with a higher degree of automation and the capability of effectively reducing labor intensity and operational difficulty, the low-pressure casting technology is more suitable for the mass production of a product with a complex shape.

The disclosure also provides use of the ceramic material described in the aforementioned technical solutions or the ceramic material prepared by the method described in the aforementioned technical solutions in protective armor plates.

In the disclosure, there are no particular limitations on the operation during the use of the ceramic material in protective armor plates, and operations well known to those skilled in the art may be adopted.

The technical solutions in the disclosure will be described clearly and completely below in conjunction with the examples of the disclosure. Apparently, the described examples are merely a part of, rather than all the of the examples of the disclosure. Based on the examples of the disclosure, all other examples that could be obtained by those of ordinary skill in the art without creative efforts shall fall within the scope of the disclosure.

### Example 1

The ceramic material consisted of a titanium alloy with a porous lattice structure, a ceramic, and an aluminum alloy;
where the porous lattice structure was provided with voids;
the ceramic was embedded in the voids; and
the aluminum alloy filled in the porous lattice structure;
the voids each were in a cylindrical shape; the voids each had a diameter of 18 mm and a height of 20 mm;
the titanium alloy had 9 voids; the 9 voids were arranged in parallel rows and columns in a horizontal direction; the distance between circle centers of two adjacent voids was 20 mm;
the voids were on the same horizontal surface, and disposed in three rows and three columns;
the structural unit in the porous lattice structure had a dimension of 12×12×12 mm; the volume fraction of the structural unit was 10%;
the titanium alloy was TC4;
the ceramic was cylindrical in shape, and was made of SiC;
the designation of the aluminum alloy was A356;
the mathematical formula of the structural unit in the porous lattice structure was shown in Equation I:

$$∅ ( r ) = cos ( 2 π x ) + cos ( 2 π y ) + cos ( 2 π z ) = C ; \qquad Equation I$$

in Equation I, x, y and z were the spatial coordinates of curved face points, and C was a constant.

The method for preparing the ceramic material was performed as follows:
(1) a three-dimensional model of the titanium alloy was constructed using Matlab software: After 10% of a volume fraction design was completed, a model file was exported in the format of x_t, and then the model was imported to Magics 24.0 software, and the dimension of structural unit was set to be 12×12×12 mm; and then the model was dragged to a processing platform interface, and slicing was executed to generate a Cli file; after the completion of primary slicing, an EPHatch software was opened, and titanium alloy process package was selected for secondary slicing; after the filling parameters were confirmed, the settings were saved to obtain the dimensional data of the titanium alloy;
(2) a titanium substrate was mounted in a molding chamber, and then titanium alloy powder uniformly filled in a powder bin, followed by setting critical process parameters for a selective laser melting device: the substrate temperature was set to 120° C., the feed base was adjusted to 1.1, the feed multiple was set to 1.2, the air flow rate of fan was set to 3.5 m/s, the oxygen content was controlled to be within 0.1 wt %, and both the pressure of chamber and the differential pressure of filtering screen were set to 45 mbar; the laser scan speed was set to 1,000 mm/s, the laser power was adjusted to 230 W, the scan spacing was set to 0.08 mm, and the scan delay time was 12 μs; finally, the molding chamber was charged with argon, and the device was started for additive manufacturing; after the additive manufacturing, the titanium alloy was put in a beaker and immersed in a NaOH solution with a mass concentration of 5%, and 20 min of alkali washing was performed; after the alkali washing, the titanium alloy was transferred into a hydrochloric acid solution with a mass concentration of 5%, and 20 min of acid washing was performed; after the acid washing, the titanium alloy was thoroughly washed with alcohol, and the cleaned titanium alloy was immersed in a plating assistant agent solution containing 8.3 wt % of K₂ZrF₆ and 0.08 wt % of NaF at a temperature of 80° C. for 20 min; and the titanium alloy was then taken out and placed in an oven at 200° C. and dried therein for 15 min, so as to obtain the treated titanium alloy;
(3) the ceramic surface was sanded using a sandpaper abrasive, followed by performing 10 min of etching with a 5 wt % hydrofluoric acid solution; and then the ceramic was immersed in a 1 wt % (3-aminopropyl)triethoxysilane solution for 15 min, and taken out and placed in an oven at 200° C. and dried therein for 15 min; and then the ceramic after surface treatment was precisely placed in the cylindrical voids of the titanium alloy obtained in step (2) to obtain an intermediate;
(4) the intermediate obtained in step (3) was placed in a lower mold of an upper chamber of a low-pressure casting machine, and the upper mold was mounted to close mold, and then the preheating system of the upper chamber was activated, a heating rod was correctly inserted into a preheating hole designed for the mold, the preheating temperature was set to 350° C., and the temperature was maintained for 15 min; next, the lower chamber was opened, and the aluminum alloy filled in, and the chamber was closed, and then the smelting heating system was started, and the current output of electrode of electromagnetic pump was set to 1,300 A in the control system, and meanwhile the current intensity in the electromagnetic coil was maintained at 50 A, and a smelting temperature of 700° C. was maintained for 1 h; during the smelting of aluminum alloy, the upper chamber of the low-pressure casting machine was vacuumized to 3.0×10² Pa using a vacuum pump, and then a diffusion pump was started to set the vacuum degree of the upper chamber to 2×10⁻¹ Pa; and then the casting of aluminum alloy molten liquid was started, the lower chamber of the low-pressure casting machine was inflated, and the pressure was adjusted to 0.4 MPa and maintained for 15 min, so that the aluminum alloy molten liquid in the lower chamber was pressed into the mold of the upper chamber to undergo a solid-liquid compounding with the intermediate; after the completion of casting, the burrs and rough portions on casting surface were removed using an emery wheel, followed by performing a precise cutting with a computer numerically controlled machine tool, so as to obtain the ceramic material.

The structural schematic diagram of the structural unit with a volume fraction of 10% in the titanium alloy of Example 1 is shown in FIG. 2.

As can be seen from FIG. 2, the titanium alloy has a porous lattice structure.

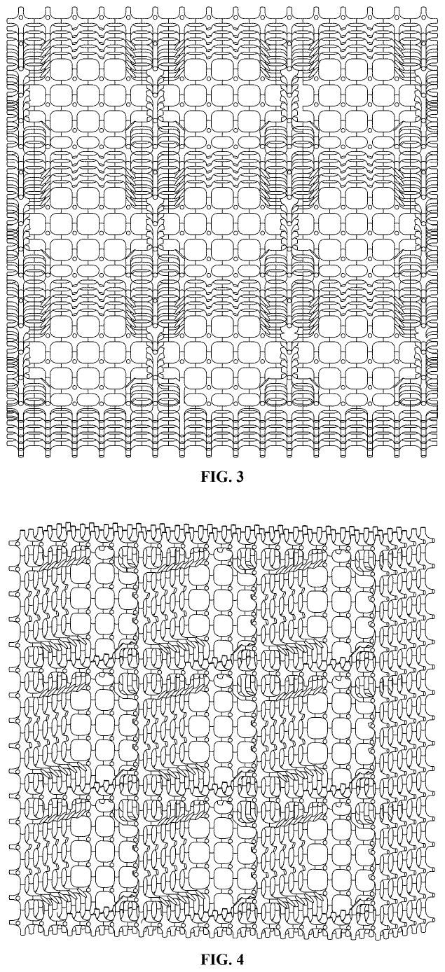

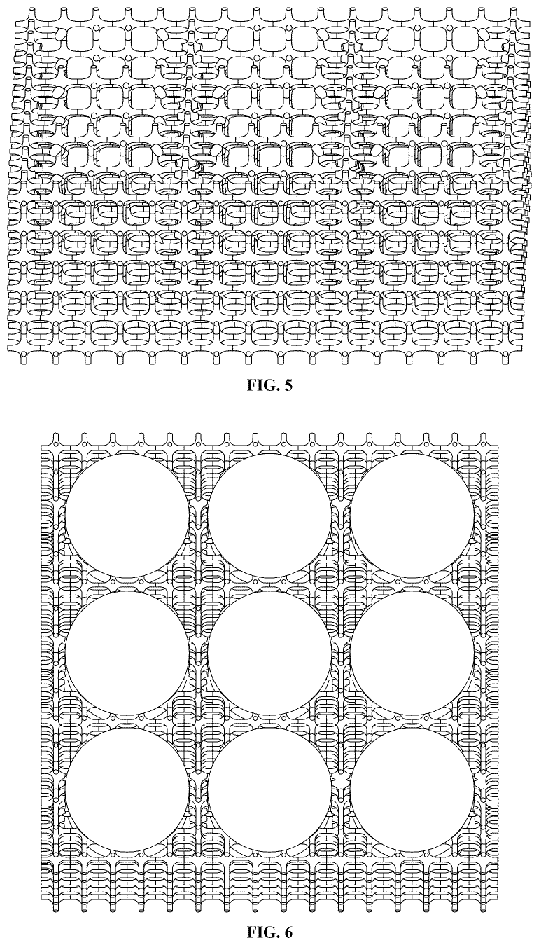

The structural schematic diagram of a top view of the titanium alloy in Example 1 is shown in FIG. 3; The structural schematic diagram of the titanium alloy in Example 1 is shown in FIGS. 4 and 5.

As can be seen from FIGS. 3-5, the titanium alloy of the disclosure has a porous lattice structure provided with cylindrical voids, and the cylindrical voids are disposed on the same horizontal surface, and arranged in three rows and three columns.

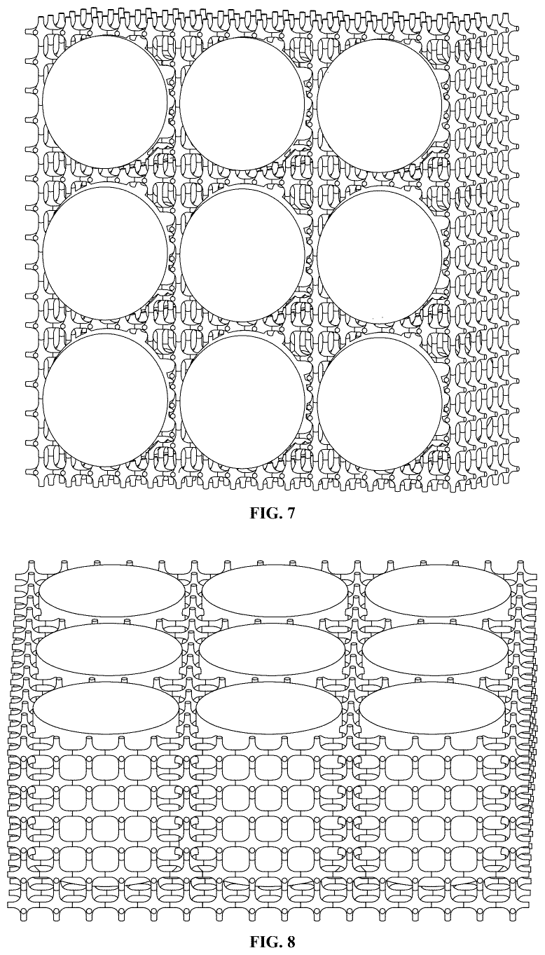

The structural schematic diagram of a top view of the intermediate in Example 1 is shown in FIG. 6; the structural schematic diagram of the intermediate in Example 1 is shown in FIGS. 7 and 8.

The structure of the intermediate of the disclosure can be clearly known from FIGS. 6-8.

The structural schematic diagram of the low-pressure casting machine used in Example 1 is shown in FIG. 10.

A defect analysis was performed for the inside of the ceramic material prepared in Example 1, using industrial CT scanning technology.

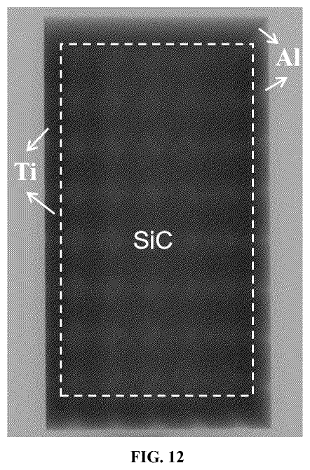

The industrial CT diagram of the ceramic material prepared in Example 1 is shown in FIG. 11.

As can be seen from FIG. 11, a good interpenetrating structure of black titanium alloy scaffold and gray aluminum alloy is achieved, with no cracks or pores at the interface; and through a further observation, it can be known that the light-gray virtual image in the center of image is the projection of cylindrical protective ceramic on a vertical surface, the ceramic with a diameter of 18 mm and a height of 20 mm are tightly confined inside, and the whole material is dense and defect-free.

### Example 2

The ceramic material consisted of a titanium alloy with a porous lattice structure, a ceramic, and an aluminum alloy;
where the porous lattice structure was provided with voids;
the ceramic was embedded in the voids; and
the aluminum alloy filled in the porous lattice structure;
the voids each were in a cylindrical shape; the voids each had a diameter of 18 mm and a height of 30 mm;
the titanium alloy had 9 voids; the 9 voids were arranged in parallel rows and columns in a horizontal direction; the distance between circle centers of two adjacent voids was 20 mm;
the voids were on the same horizontal surface, and disposed in three rows and three columns;
the structural unit in the porous lattice structure had a dimension of 15×15×15 mm; the volume fraction of the structural unit was 20%;
the mathematical formula of the structural unit in the porous lattice structure was shown in Equation I:

$$∅ ( r ) = cos ( 2 π x ) + cos ( 2 π y ) + cos ( 2 π z ) = C ; \qquad Equation I$$

in Equation I, x, y and z were the spatial coordinates of curved face points, and C was a constant;
the titanium alloy was Ti-6Al-7Nb;
the ceramic was cylindrical in shape, and was made of SiC;
the designation of the aluminum alloy was A356.

The method for preparing the ceramic material was performed as follows:
(1) a three-dimensional model of the titanium alloy was constructed, using UG software: after 20% of a volume fraction design was completed, a model file was exported in the format of x_t, and then the model was imported to Magics 24.0 software, and the dimension of structural unit was set to be 15×15×15 mm; and then the model was dragged to a processing platform interface, and slicing was executed to generate a Cli file; after the completion of primary slicing, an EPHatch software was opened, and titanium alloy process package was selected for secondary slicing; after the filling parameters were confirmed, the settings were saved to obtain the dimensional data of the titanium alloy;
(2) a titanium substrate was mounted in a molding chamber, and then titanium alloy powder uniformly filled in a powder bin, followed by setting critical process parameters for a selective laser melting device: the substrate temperature was set to 120° C., the feed base was adjusted to 1.1, the feed multiple was set to 1.2, the air flow rate of fan was set to 3.5 m/s, the oxygen content was controlled to be within 0.1 wt %, and both the pressure of chamber and the differential pressure of filtering screen were set to 45 mbar; the laser scan speed was set to 1,200 mm/s, the laser power was adjusted to 240 W, the scan spacing was set to 0.08 mm, and the scan delay time was 13 μs; finally, the molding chamber was charged with argon, and the device was started for additive manufacturing; after the additive manufacturing, the titanium alloy was put in a beaker and immersed in a NaOH solution with a mass concentration of 10%, and 15 min of alkali washing was performed; after the alkali washing, the titanium alloy was transferred into a hydrochloric acid solution with a mass concentration of 10%, and 15 min of acid washing was performed; after the acid washing, the titanium alloy was thoroughly washed with alcohol, and the cleaned titanium alloy was immersed in a plating assistant agent solution containing 8.3 wt % of K₂ZrF₆ and 0.08 wt % of NaF at a temperature of 90° C. for 15 min; and then, the titanium alloy was then taken out and placed in an oven at 200° C. and dried therein for 10 min, so as to obtain the treated titanium alloy;
(3) the ceramic surface was sanded using a sandpaper abrasive, followed by performing 15 min of etching with a 8 wt % hydrofluoric acid solution; and then the ceramic was immersed in a 1 wt % (3-aminopropyl)triethoxysilane solution for 8 min, and taken out and placed in an oven at 200° C. and dried therein for 15 min, and then the ceramic after surface treatment was precisely placed in the cylindrical voids of the titanium alloy obtained in step (2) to obtain an intermediate;
(4) the intermediate obtained in step (3) was placed in a lower mold of an upper chamber of a low-pressure casting machine, and the upper mold was mounted to close mold, and then the preheating system of the upper chamber was activated, a heating rod was correctly inserted into a preheating hole designed for the mold, the preheating temperature was set as 400° C., and the temperature was maintained for 15 min; next, a lower chamber was opened, and the aluminum alloy filled in, and the chamber was closed, and then the smelting heating system was started, and the current output of electrode of electromagnetic pump was set as 1,200 A in the control system, and meanwhile the current intensity in the electromagnetic coil was maintained at 40 A, and a smelting temperature of 680° C. was maintained for 1 h; during the smelting of the aluminum alloy, the upper chamber of the low-pressure casting machine was vacuumized to a vacuum degree of 3.0×10² Pa using a vacuum pump, and then a diffusion pump was started to set the vacuum degree of the upper chamber to 2×10⁻¹ Pa; and then the casting of the aluminum alloy molten liquid was started, the lower chamber of the low-pressure casting machine was inflated, and the pressure was adjusted to 0.5 MPa and maintained for 15 min, so that the aluminum alloy molten liquid in the lower chamber was pressed into the mold of the upper chamber to undergo a solid-liquid compounding with the intermediate; after the completion of casting, the burrs and rough portions on casting surface were removed using an emery wheel, followed by performing a precise cutting with a computer numerically controlled machine tool, so as to obtain the ceramic material.

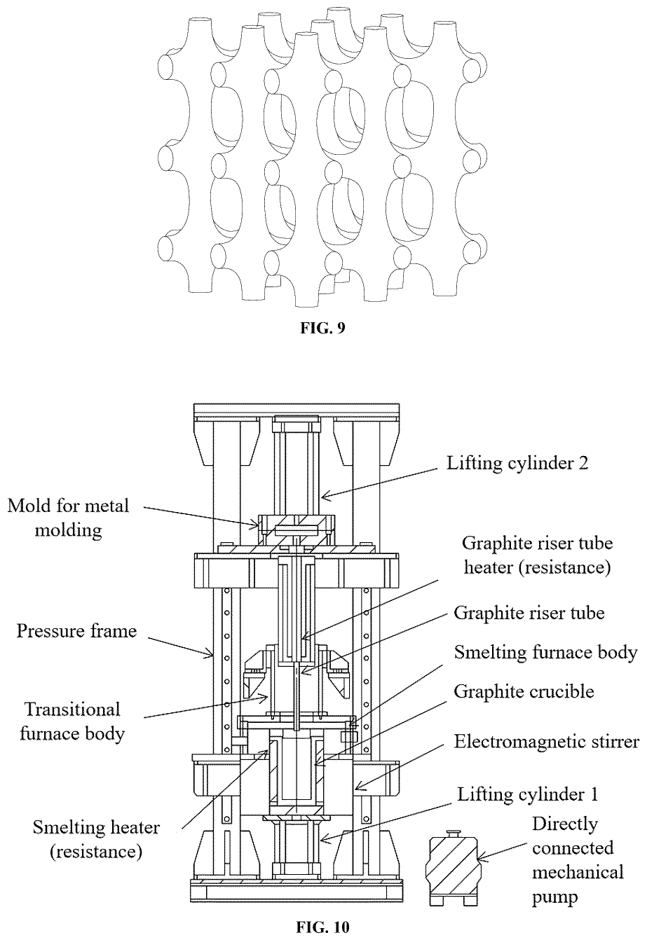

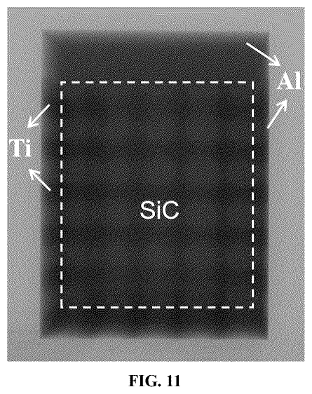

The structural schematic diagram of the structural unit with a volume fraction of 20% in the titanium alloy of Example 2 is shown in FIG. 9.

As can be seen from FIG. 9, the titanium alloy has a porous lattice structure.

The internal defect analysis of the ceramic material prepared in Example 2 was performed using industrial CT scanning techniques.

The industrial CT diagram of the ceramic material prepared in Example 2 is shown in FIG. 12.

As can be seen from FIG. 12, a good interpenetrating structure of black titanium alloy scaffold and gray aluminum alloy was achieved, with no cracks or pores at the interface; and through a further observation, it can be known that the light-gray virtual image in the center of image was the projection of cylindrical protective ceramic on a vertical surface, the ceramic with a diameter of 18 mm and a height of 30 mm were tightly confined inside, and the whole material was dense and defect-free.

By comparing FIG. 11 and FIG. 12, it could be seen that the black scaffold of Example 1 with a volume fraction of 10% occupies less space, and was, as a whole, in the form of a regular frame under the action of projection; while the black titanium alloy scaffold of Example 2 with a volume fraction of 20% occupies a significantly-increased space, and scaffold unit is thicker, similar to a ball-to-ball connection, and the projection of frame is relatively disordered.

It can be see from the aforementioned examples that the ceramic material provided by the disclosure could realize a good confinement encapsulation of the ceramic, and the whole material is dense, without obvious defects.

The descriptions above are merely the preferred embodiments of the disclosure. It should be noted that several improvements and modifications may also be made by the ordinary artisans in the art without departing from the principle of the disclosure, and these improvements and modifications should also be deemed as falling within the scope of the disclosure.

What is claimed is:

1. A ceramic material, comprising a titanium alloy with a porous lattice structure, a ceramic, and an aluminum alloy; wherein
the porous lattice structure is provided with voids;
the ceramic is embedded in the voids; and
the aluminum alloy fills in the porous lattice structure.

2. The ceramic material according to claim 1, wherein the voids each are in a cylindrical shape.

3. The ceramic material according to claim 1, wherein the voids each have a diameter of 17-19 mm and a height of 10-35 mm.

4. The ceramic material according to claim 2, wherein the voids each have a diameter of 17-19 mm and a height of 10-35 mm.

5. The ceramic material according to claim 1, wherein a structural unit in the porous lattice structure has a dimension selected from the group consisting of 9×9×9 mm, 12×12×12 mm and 15×15×15 mm.

6. The ceramic material according to claim 5, wherein a volume fraction of the structural unit is in a range of 10-30%.

7. A method for preparing the ceramic material according to claim 1, comprising steps of:
1) preparing the titanium alloy using an additive manufacturing process;
2) embedding the ceramic in the voids of the titanium alloy obtained in step 1) to obtain an intermediate; and
3) casting by pouring an aluminum alloy molten liquid into the intermediate obtained in step 2), to obtain the ceramic material.

8. The method according to claim 7, wherein a laser configured in the additive manufacturing process in step 1) has a scan speed of 700-1,300 mm/s, a power of 180-270 W, a scan spacing of 0.07-0.09 mm and a scan delay time of 10-15 microseconds.

9. The method according to claim 7, wherein the aluminum alloy molten liquid in step 3) has a temperature of 680-720° C.

10. The method according to claim 7, wherein the casting in step 3) is performed in a low-pressure casting machine.

11. A protective armor plate, comprising the ceramic material according to claim 1.
